(19) United States
(12) Patent Application Publication
(10) Pub. No.: US 2023/0151298 A1
(43) Pub. Date: May 18, 2023

(54) CASTOR OIL COMPOSITION

(71) Applicant: TR Chem Solutions, LLC, Gurnee, IL (US)

(72) Inventor: Thomas James Rissmann, Gurnee, IL (US)

(21) Appl. No.: 17/699,999

(22) Filed: Mar. 21, 2022

Related U.S. Application Data
(60) Provisional application No. 63/279,393, filed on Nov. 15, 2021.

(51) Int. Cl. C11C 3/00; C11D 1/06; C10M 129/68

(52) U.S. Cl. CPC C11C 3/006; C11D 1/06; C10M 129/68; C10N 2020/091

(57) ABSTRACT

An example composition according to the present disclosure includes, among other possible things, water and an active product including ethoxylated castor oil, wherein the ethoxylated castor oil has a degree of ethoxylation defined as CO—X, where the ethoxylated castor oil is a reaction product of castor oil and X moles of ethylene oxide. The active product comprises between about 20 percent and about 50 percent by weight of the composition. The ethoxylated castor oil is dispersible or soluble in the water such that the composition is homogenous, and the composition has a viscosity of about 10,000 cps or less.

### CROSS-REFERENCE TO RELATED APPLICATIONS

This patent application claims the benefit of U.S. Provisional Application No. 63/279,393, filed Nov. 15, 2021, which is hereby incorporated by reference in its entirety herein.

### BACKGROUND

This application relates generally to a composition comprising ethoxylated castor oil. The composition can be used to provide a shine and darkening to materials, such as tires, trim, and/or interior surface of a vehicle. In other examples, the composition can be used as a lubricant.

### SUMMARY

An example composition according to the present disclosure includes, among other possible things, water and an active product including ethoxylated castor oil, wherein the ethoxylated castor oil has a degree of ethoxylation defined as CO—X, where the ethoxylated castor oil is a reaction product of castor oil and X moles of ethylene oxide. The active product comprises between about 20 percent and about 50 percent by weight of the composition. The ethoxylated castor oil is dispersible or soluble in the water such that the composition is homogenous, and the composition has a viscosity of about 10,000 cps or less.

### DETAILED DESCRIPTION

Compositions of ethoxylated castor oils as described below can be used to add shine and darkening to certain materials, such as tires and trim, and vehicle interior surfaces such as dashboards. The ethoxylated castor oil compositions described herein have been found to provide comparable or improved shine and darkening to tires/trim/other surfaces as compared to silicone-based products. Though silicon-based products provide good shine/darkening to tires and other materials, they have certain drawbacks. For example, silicone from the silicone-based products can become airborne, which is not desirable for certain working conditions such as in body/paint shops, while ethoxylated castor oil compositions do not have any components that would become airborne during application/use. The ethoxylated castor oil compositions are also less expensive than silicone-based products for surface shining/darkening. Moreover, ethoxylated castor oil compositions are biodegradable, whereas silicone-based products are not easily biodegradable. Therefore, the ethoxylated castor oil compositions are more environmentally friendly than silicone-based products for surface shining/darkening. Lastly, the castor oil compositions described herein can be applied to wet surfaces such as in tunnel washes. Compositions of ethoxylated castor oils can also replace silicone-based lubricants in other applications.

Ethoxylated castor oil is commercially available and relatively inexpensive. For example, castor oil can be reacted with ethylene oxide to form polyoxyethylene castor oil. “Ethoxylated” refers to the addition of ethylene oxide (C₂H₄O) groups to a substrate, in this case, castor oil (which has chemical formula C₅₇H₁₀₄O₉). Castor oil can be ethoxylated to various degrees corresponding to the amount of ethylene oxide groups added to the castor oil. Some example ethoxylated castor oils are CO-5, CO-16, CO-25, CO-30, and CO-36. CO-5 is polyoxyethylene castor oil which is formed by reacting 5 moles of ethylene oxide with castor oil. CO-16 is polyoxyethylene castor oil formed by reacting 16 moles of ethylene oxide with castor oil, and so on. Though the below description refers to these particular polyoxyethylene castor oils, it should be understood that other ethoxylated castor oils from other manufacturers are also available and contemplated by this disclosure, and are expected to exhibit the same trends and physical/chemical properties. CO-5, CO-16, CO-25, CO-30, and CO-36 are available from Ethox Chemicals, LLC (Greenville, S.C.). CO-30 is also available from Vantage Specialties, Inc. (Chicago, Ill.).

An example embodiment composition generally includes ethoxylated castor oil and water. Ethoxylated castor oil and water forms a homogenous mixture depending on the degree of ethoxylation and concentration. Castor oil provides shine and darkening to surfaces, and can also be used as a lubricant as discussed more below. Ethoxylating the castor oil makes castor oil into a surfactant, which improves its solubility and/or dispersibility in water. In general, the degree of ethoxylation and the solubility are directly related, e.g., as degree of ethoxylation increases the solubility increases. Table 1 below shows the HLB Values and solubility or dispersibility for castor oils with various degrees of ethoxylation in water. The HLB (“hydrophilic-lipophilic balance”) Value is a measure of the degree of hydrophilicity of a surfactant, which is related to its dispersibility or solubility (e.g., the more hydrophilic a surfactant is, the higher the HLB value, and the more soluble it is in water).

TABLE 1

| | CO-5 | CO-16 | CO-25 | CO-30 | CO-36 |
|---|---|---|---|---|---|
| HLB Value | 4 | 8.6 | 10.8 | 11.9 | 13 |
| Water | Insol- | Insol- | Dis- | Dis- | Sol- |
| Soluble | uble | uble | persible | persible | uble |

Because the castor oil experiences increased dispersibility or solubility in water as its degree of ethoxylation increases, ethoxylated castor oils with certain degrees of ethoxylation, e.g., castor oils that are more highly ethoxylated than CO-16 and/or have a higher HLB Value than about 9 can be mixed with water to lower the viscosity of the overall composition for ease of manufacture, bottling, and application, as will be discussed in more detail below.

For the particular application of shining/darkening surfaces, ethoxylating the castor oil also reduces the absorption of the castor oil into the material of the surfaces, so that some of the ethoxylated castor oil will remain on the surface and some will absorb into the material. Absorption provides darkening of the surfaces, while ethoxylated castor oil on the surface provides shine. The ethoxylated castor oil on the tire surface forms a film that also provides water repellency to the surface, and has good staying power on the surface even at high speeds. The degree of ethoxylation of the castor oil and the amount of the ethoxylated castor oil are optimized to achieve the desired shine and darkening of the surface.

In some examples, the composition optionally includes other additives such as a preservative and/or biocide, a thickener such as a polyacrylate, a fragrance, surfactants (which improve shine, for instance), polypropylene glycol, and/or stabilizers such as polyethylene glycol (PEG)-based stabilizers or glycol ether. One example polypropylene glycol has molecular weight 500. More particularly, the composition may include up to about 10% by weight additives.

Glycol ether in particular improves the freeze/thaw stability of the compositions and also provides a clear amber liquid composition. Glycol ether may itself contribute to the shine effect of the composition, though it is relatively volatile and will eventually evaporate off of the surface to which the composition is applied. Additionally, glycol ether helps clean the surface to which the composition is being applied, improving the spreadability of the composition on the surface and in turn improving the darkening and shine effect provided by the composition.

Example surfactants are glycerin, polysorbate 80, and anionic surfactants, or combinations thereof. Surfactants improve the ability of the ethoxylated castor oil to mix with water, which in turn allows for lowering the viscosity of ethoxylated castor oil, as discussed above. Because of the improved mixing of water and ethoxylated castor oil in the composition, surfactants improve shine of the surface and the length of time the shine lasts by slowing the absorption of the ethoxylated castor oil/water mixture into the surface. Accordingly, more ethoxylated castor oil remains on the surface of the water for a longer period of time, so that the surface has a shiny appearance. In certain examples, the surfactants can improve the lasting time of the shine to a period on the order of weeks, as compared to a composition without surfactants that has a shine lasting time on the order of days. The shine lasting time is ultimately dependent on a combination of the makeup of the composition and the makeup of the surface itself.

Example biocides are Acticide® LA-1206 and Acticide® MV, which are available from Thor Specialties, Inc. (Shelton, Conn.).

In a particular example, the composition includes between about 1-10% by weight glycerin and between about 1-10% by weight polysorbate 80.

The composition is generally homogenous, e.g., the ethoxylated castor oil is dispersed or dissolved in the water, and has a viscosity that enables ease of use and manufacture, and in particular, does not require specialized mixing equipment. For example, the viscosity is less than about 20,000 centipoise (cps). In a further example, the viscosity is less than 10,000 cps. In a still further example, the viscosity is less than about 2500 cps. Because the viscosity of the present composition is suitable without the need for additional thickeners, the resulting composition will not clog spray lines in tunnel washes when used in that application, and in other applications is suitable for hand-held spray bottle application as discussed herein.

In general, the polar/hydrophilic ethoxy groups of ethoxylated castor oils interact with water which affects the viscosity of the ethoxylated castor oil/water mixture. Tables 2-5 below show the viscosity for various ethoxylated castor oils at various concentrations by weight percent with water. FIG. 1 shows the data from Tables 2, 4, and 5 plotted by HLB value (discussed above).

TABLE 2

| Ingredient | Wt % | Viscosity | Supplier |
|---|---|---|---|
| CO-25 | 30 | 40 | Ethox Chemical |
| CO-25 | 35 | 240 | Ethox Chemical |
| CO-25 | 40 | 2480 | Ethox Chemical |
| CO-25 | 45 | N/A (too high | Ethox Chemical |
| | | to measure) | |

TABLE 3

| Ingredient | Wt % | Viscosity | Supplier |
|---|---|---|---|
| CO-25 | 30 | 40 | Vantage Specialties |
| CO-25 | 35 | 240 | Vantage Specialties |
| CO-25 | 40 | 2560 | Vantage Specialties |
| CO-25 | 45 | N/A (too high | Vantage Specialties |
| | | to measure) | |

TABLE 4

| Ingredient | Wt % | Viscosity | Supplier |
|---|---|---|---|
| CO-30 | 30 | 80 | Vantage Specialties |
| CO-30 | 35 | 380 | Vantage Specialties |
| CO-30 | 40 | 2700 | Vantage Specialties |
| CO-30 | 45 | 11200 | Vantage Specialties |

TABLE 5

| Ingredient | Wt % | Viscosity | Supplier |
|---|---|---|---|
| CO-36 | 30 | 60 | Vantage Specialties |
| CO-36 | 35 | 240 | Vantage Specialties |
| CO-36 | 40 | 1140 | Vantage Specialties |
| CO-36 | 45 | 4200 | Vantage Specialties |

As shown from the data in Tables 2-5 and FIG. 1, viscosity generally increases with concentration for castor oils with all degrees of ethoxylation. Additionally, the castor oil with the highest degree of ethoxylation measured, CO-36, had the lowest viscosity at higher concentrations, while the castor oil with the lowest degree of ethoxylation measured, CO-25, had the highest viscosity at higher concentrations.

As discussed above, lower viscosity compositions are generally simpler and less expensive to manufacture, bottle, and apply without specialized equipment (e.g., with a handheld spray bottle). For instance, such low viscosity compositions can have viscosity between about 100 and 250 cps. Applicators used in tunnel and bay car washing facilities typically require compositions with viscosities high enough that the composition can be effectively applied to a vehicle without falling off of application brushes and/or sponges. For instance, the optimal viscosity may be between about 800 and 2500 cps at room temperature. Accordingly, the viscosity of the composition is selected by balancing the manufacturing and use economies with achieving a desired level of shine and darkening of the tire.

An example embodiment composition generally includes between about 20 and 50% “active product,” e.g., ethoxylated castor oil, and the balance water and the other optional additives discussed above. In a particular example, the composition includes about 35%-45% active product. In this range, the higher the degree of ethoxylation, the lower the viscosity of the castor oil composition, as shown in Tables 2-5 and FIG. 1.

One example composition includes 30% ethoxylated castor oil. When this composition is applied to a tire or other surface, the shine and darkening increases with degree of ethoxylation up to CO-25. Ethoxylated castor oil/water compositions with degrees of ethoxylation higher than CO-25 (e.g., CO-30 and CO-36) tend to exhibit a drop-off in shine and darkening of the tire because the tire material absorbs the ethoxylated castor oil, resulting in a matte rather than shiny appearance.

In some examples, castor oils with various degrees of ethoxylation are blended to form the active product in the composition to maximize the amount of active product (and thereby the resulting shine and darkening of the tire or other surface) while maintaining a desirable viscosity as discussed above. Moreover, as discussed above, absorption of the ethoxylated castor oil into the tire/trim/other surface provides darkening of the surface, while ethoxylated castor oil on the surface provides shine. More highly ethoxylated castor oils tend to absorb into the surface, while lower ethoxylation castor oils tend to remain on the surface. Thus, a blend of highly ethoxylated castor oil with low ethoxylation castor oil provides good darkening and shine.

For instance, a composition comprising 30% CO-25 has a viscosity of 40 cps, whereas a composition comprising 40% CO-25 has a much higher viscosity approaching 10,000 cps. At 42% CO-25, the viscosity is about 20,000 cps. However, a composition comprising 35% CO-25 and 5% CO-35 has a viscosity of about 2000 cps.

One example blended composition includes CO-10 and CO-25 in a cumulative amount of between about 25-45% by weight, up to 10% of any of the additives discussed above, and the balance water. This example composition has a viscosity less than about 2500 cps. Moreover, this example composition exhibits good stability compared to other blended compositions. For instance, it has been discovered that blends of highly ethoxylated castor oils such as CO-36 with minimally ethoxylated castor oils such as CO-5 exhibit separation, whereas the blend of two castor oils with a more similar amount of ethoxylation to one another such as CO-10 and CO-25 generally does not. In the event of separation, however, the mixture could be stabilized by the addition of stabilizing additives such as PEG (polyethylene glycol)-based additives. In a particular example, PEG 600 DO (polyethylene glycol di-oleate or PEG 600 DOT (polyethylene di-tallate) could be used. The amount of PEG-based stabilizers could be approximately 0.9%, in some examples.

A particular example blended composition comprises about 41% active product, where the active product is a blend of CO-10 and CO-25 in substantially equal amounts, e.g., the amounts of CO-10 and CO-25 are within about 5% of one another. Said another way, the composition includes 18-23% CO-10 and 18-23% CO-25 for a total of 41% active product (e.g., the sum of amounts of CO-10 and CO-25 is 41%). In a more particular example, the composition includes 19.9% CO-10, 22.4% CO-25, 57.6% water, and 0.1% additive from the additives discussed above. For instance, the additive could be Acticide® LA-1206, which is a biocide. As noted above, CO-10 is insoluble in water and CO-25 at any concentration over 40% is very thick. However, it has been found that the viscosity of the composition in this example is about 1500 cps.

Another particular example blended composition comprises about 37% active product where the active product includes 22% CO-10 and 15% CO-25, up to about 10% any of the additives discussed above, and the balance water. The viscosity of the composition in this example is about 900 cps. In a further example, the composition described above is a concentrated composition and is diluted down to about 30% active product to create a working composition. The working composition has a viscosity that is optimal for spraying onto a tire or other surface with a hand-held spray. For example, the working composition has a viscosity of between about 40 and 100 cps.

Another particular example blended composition comprises about 32% active product where the active product includes about 7% CO-10 and about 25% CO-25, up to about 10% any of the additives discussed above, and the balance water. In particular, the additives may comprise about 4% by weight glycol ether and about 0.1% by weight Acticide® MV. In this example, glycol ether provides improved freeze/thaw stability. This example composition is a clear amber liquid. The viscosity of this composition is about 232 cps.

Another example composition includes 29% by weight CO-25 ethoxylated castor oil, 3% by weight glycerin, and 3% by weight polysorbate 80.

The above-described compositions are also useful as lubricants, and particularly, to replace silicone-based lubricants in various types of processes. For example, the above-described compositions can be used for web printing. Web-printing is a method of high-volume printing which utilizes a silicone-based emulsion to provide lubricity to the printed page in order to reduce anti-marring of the ink. As another example, the above-described compositions can be used as lubricants for canning or bottling processes.

As used herein, the terms “approximately” and “about” have the typical meaning in the art, however in a particular example “about” or “approximately” can mean deviations of up to 10% of the values described herein.

Although example embodiments have been disclosed, a worker of ordinary skill in this art would recognize that certain modifications would come within the scope of this disclosure. For that reason, the following claims should be studied to determine the scope and content of this disclosure.

What is claimed is:

1. A composition comprising:
water;
an active product including ethoxylated castor oil, wherein the ethoxylated castor oil has a degree of ethoxylation defined as CO—X, where the ethoxylated castor oil is a reaction product of castor oil and X moles of ethylene oxide;
wherein the active product comprises between about 20 percent and about 50 percent by weight of the composition, and
wherein the ethoxylated castor oil is dispersible or soluble in the water such that the composition is homogenous, and wherein the composition has a viscosity of about 10,000 cps or less.

2. The composition as set forth in claim 1, wherein X is 5, 16, 25, or 30.

3. The composition as set forth in claim 2, wherein X is 25.

4. The composition as set forth in claim 3, wherein the active product comprises about 30% by weight of the composition.

5. The composition as set forth in claim 1, wherein the ethoxylated castor oil includes a first ethoxylated castor oil having a first degree of ethoxylation and a second ethoxylated castor oil having a second degree of ethoxylation.

6. The composition as set forth in claim 5, wherein the first ethoxylated castor oil is CO-10 and the second ethoxylated castor oil is CO-25.

7. The composition as set forth in claim 6, wherein the active product comprises between about 35 and 45 percent by weight of the composition.

8. The composition as set forth in claim 7, wherein the active product includes substantially equal amounts of CO-10 and CO-25.

9. The composition as set forth in claim 7, wherein the active product includes about 22 percent CO-10 by weight of the composition and about 15 percent CO-25 by weight of the composition.

10. The composition as set forth in claim 1, wherein the composition includes between about 35 and about 45 percent of the active product.

11. The composition as set forth in claim 1, wherein the composition further includes at least one additive.

12. The composition as set forth in claim 11 wherein X is 25.

13. The composition as set forth in claim 11, wherein the at least one additive includes at least one of a preservative, biocide, a thickener, a fragrance, a surfactant, and a stabilizer.

14. The composition as set forth in claim 13, wherein the surfactant includes at least one of glycerin, polysorbate 80, and an anionic surfactants.

15. The composition as set forth in claim 14, wherein the surfactant includes glycerin and polysorbate 80.

16. The composition as set forth in claim 11, wherein the composition includes up to about 10 percent by weight of the additive.

17. The composition as set forth in claim 1, wherein the viscosity of the composition is about 2500 cps or less.

18. The composition as set forth in claim 1, wherein the composition is biodegradable.

19. The composition as set forth in claim 1, wherein the composition is sprayable.

20. The composition as set forth in claim 1, wherein the composition is free from silicone.
